(19) United States
(12) Patent Application Publication
(10) Pub. No.: US 2010/0047584 A1
(43) Pub. Date: Feb. 25, 2010

(54) Vehicle Paint System With UV Protection

(75) Inventors: Mary Sue Acker, Howell, MI (US); Phuong-Anh P. Ngo, Troy, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/195,465

(22) Filed: Aug. 21, 2008

(51) Int. Cl. B32B 27/38; C25D 9/00

(52) U.S. Cl. 428/413; 205/316

(57) ABSTRACT

A vehicle paint system with UV protection for coating a base material and method of application to a vehicle component is disclosed. The vehicle paint system may include an anti-corrosion electro-deposition layer covering the base material; a basecoat with a UV stabilizer additive covering the electro-deposition layer, with the UV stabilizer additive including benzotriazole and a colored pigment that offsets a yellow color imparted by the benzotriazole; and a clearcoat covering the basecoat. This UV stabilizer additive may be in the clearcoat instead of or in addition to the basecoat.

### BACKGROUND OF INVENTION

The present invention relates generally to coating of automotive vehicle bodies, and more particularly to UV protection provided in the coatings of vehicle bodies.

The coatings applied to automotive vehicle bodies not only provide a desirable aesthetic appearance for the vehicle, but also protect the vehicle bodies from the elements and help prevent the aesthetic appearance from deteriorating. Some electro-deposition (ELPO) processes, used for corrosion resistance on vehicle bodies, use an epoxy based product. However, this epoxy can break down when exposed to ultraviolet (UV) light (similar to the concept of steel rusting due to exposure to oxygen). In order to prevent this break down due to UV light exposure, a primer surfacer is applied over the ELPO layer. During the coating process, the primer surfacer undergoes an inspection and moist sanding process before a basecoat and clearcoat are applied. Current basecoat and clearcoat applications may contain UV stabilizer additives that protect up to about 400 nanometers (nm). This UV protection is sufficient when used in conjunction with the primer surfacer layer, but is not sufficient if there were no primer surfacer layer.

### SUMMARY OF INVENTION

An embodiment contemplates a vehicle paint system with UV protection for coating a base material of a vehicle component. The vehicle paint system may include an anti-corrosion, electro-deposition layer covering the base material; a basecoat with a UV stabilizer additive covering the electro-deposition layer, with the UV stabilizer additive including benzotriazole and a colored pigment that offsets a yellow color imparted by the benzotriazole; and a clearcoat covering the basecoat.

An embodiment contemplates a vehicle paint system with UV protection for coating a base material of a vehicle component. The vehicle paint system may include an anti-corrosion, electro-deposition layer covering the base material; a basecoat covering the electro-deposition layer; and a clearcoat with a UV stabilizer covering the basecoat, with the UV stabilizer including benzotriazole and a colored pigment that offsets a yellow color imparted by the benzotriazole.

An embodiment contemplates a method of applying coatings to a base material of a vehicle component, the method comprising the steps of: applying an electro-deposition layer to the base material; applying a basecoat having a UV stabilizer additive to the electro-deposition layer, with the UV stabilizer additive including benzotriazole and a colored pigment that offsets a yellow color imparted by the benzotriazole; and applying a clearcoat to the basecoat.

An advantage of an embodiment is that this material coating system prevents epoxy resin in the electro-deposition layer from breaking down in the presence of UV light, without the use of a primer surfacer layer. Eliminating the primer surfacer layer reduces material costs as well as production costs by eliminating the primer surfacer application step and a subsequent primer inspection and moist sanding step, which reduces the footprint of a paint shop in a vehicle assembly plant-all while still ensuring acceptable visual appearance of the vehicle over time. And, the UV protection is provided without imparting an undesirable color to the coatings.

### BRIEF DESCRIPTION OF DRAWINGS

FIG. 1 is a schematic diagram illustrating a paint process for coating a vehicle body or component.

FIG. 2 is a schematic illustration of the coatings on a base material 30 of a finished vehicle body or component.

FIG. 3 is a view similar to FIG. 2, but illustrating a second embodiment.

FIG. 4 is a view similar to FIG. 2, but illustrating a third embodiment.

FIG. 5 illustrates a chemical structure for part of the UV stabilizer additive added to a basecoat or the basecoat and clearcoat.

### DETAILED DESCRIPTION

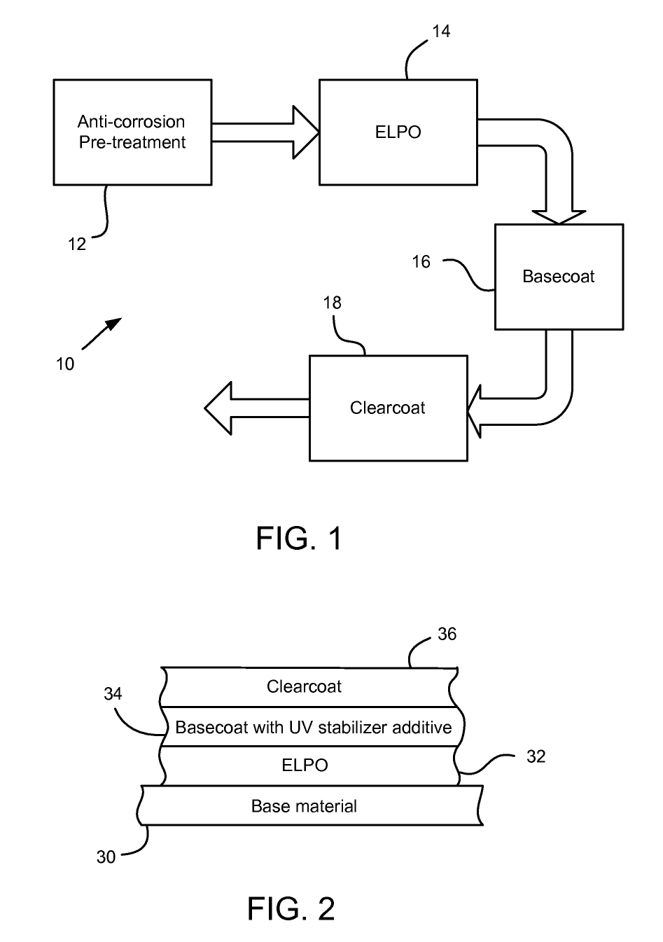

FIG. 1 schematically illustrates a vehicle body (or component) paint process, indicated generally at 10. The paint process 10 includes an anti-corrosion, pre-treatment operation 12, which may include phosphate, for cleaning the surface of the material to be coated. After this operation, the material undergoes an electro-deposition (ELPO) operation 14, i.e., an anti-corrosion electroplating bath. The material then has a basecoat applied in a basecoat operation 16. The basecoat may include a UV stabilizer additive, discussed in more detail below. The material then has a clearcoat applied over the basecoat in a clearcoat operation 18. The clearcoat may also include the UV stabilizer additive.

FIG. 2 is a schematic illustration of the coatings on a base material 30 of a finished vehicle body or component. An ELPO coat 32 is applied to the base material 30 to improve corrosion resistance. A basecoat with UV stabilizer 34 is coated over the ELPO coat 32. A clearcoat 36 is added over the basecoat with UV stabilizer layer 34.

The UV stabilizer additive in the basecoat 34 is benzotriazole (1,2,3-Benzotriazole) with a colored pigment. The benzotriazole protects into the UV visible range of about 420 nanometers (nm), which is a range that will protect against epoxy degradation in the ELPO layer 32. But the benzotriazole tends to impart a yellow color, so the UV stabilizer additive in the basecoat 34 includes the colored pigment. The colored pigment is preferably mostly red shade pigments, but other pigments may be added as well to assure the neutralization of the imparted color caused by the benzotriazole to the basecoat 34. The chemical structure of benzotriazole, referred to generally at 50, is illustrated in FIG. 5.

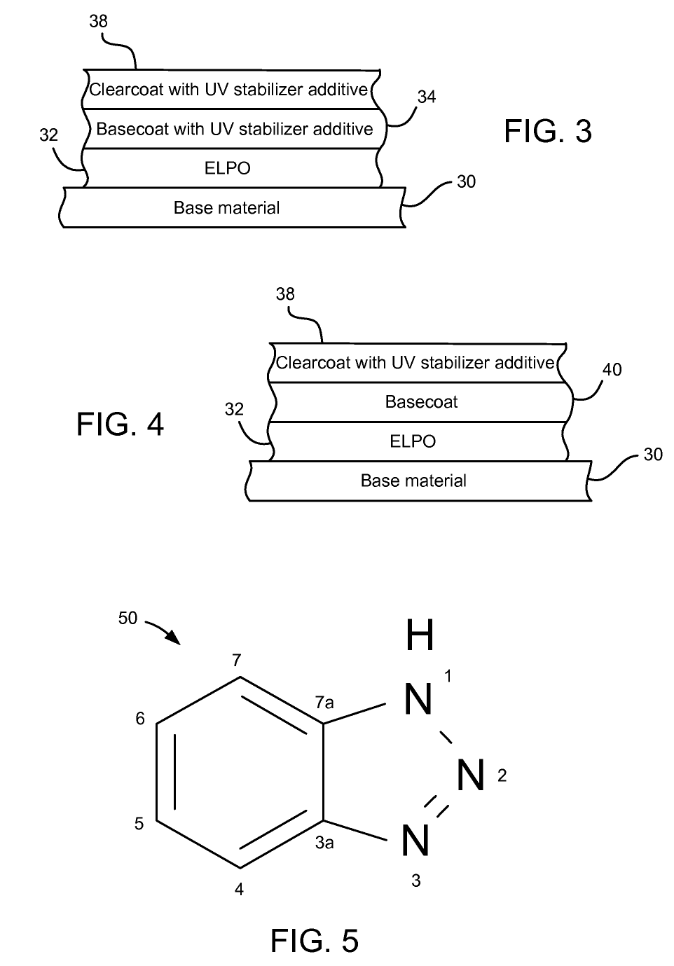

FIG. 3 is a schematic illustration of the coatings on a base material 30 of a finished vehicle body or component, according to a second embodiment. In this embodiment, the ELPO coat 32 and the basecoat with UV stabilizer 34 are the same, but the next layer is now a clearcoat with UV stabilizer additive 38. The UV stabilizer additive would again be the benzotriazole with a colored pigment.

FIG. 4 is a schematic illustration of the coatings on a base material 30 of a finished vehicle body or component, according to a third embodiment. In this embodiment, the ELPO coat 32 is the same, but the clearcoat 40 does not have the UV stabilizer additive, while the next layer is a clearcoat with UV Stabilizer additive 38. The UV stabilizer additive would again be the benzotriazole with a colored pigment.

While certain embodiments of the present invention have been described in detail, those familiar with the art to which this invention relates will recognize various alternative designs and embodiments for practicing the invention as defined by the following claims.

What is claimed is:

1. A vehicle paint system with UV protection for coating a base material of a vehicle component, the vehicle paint system comprising:
an anti-corrosion, electro-deposition layer covering the base material;
a basecoat having a UV stabilizer additive covering the electro-deposition layer, the UV stabilizer additive including benzotriazole and a colored pigment that offsets a yellow color imparted by the benzotriazole; and
a clearcoat covering the basecoat.

2. The vehicle paint system of claim 1 wherein the colored pigment is a red shade of pigment.

3. The vehicle paint system of claim 1 wherein the clearcoat has a UV stabilizer including the benzotriazole and the colored pigment that offsets the yellow color imparted by the benzotriazole.

4. The vehicle paint system of claim 1 wherein the electro-deposition layer includes epoxy.

5. A vehicle paint system with UV protection for coating a base material of a vehicle component, the vehicle paint system comprising:
an anti-corrosion, electro-deposition layer covering the base material;
a basecoat covering the electro-deposition layer; and
a clearcoat with a UV stabilizer covering the basecoat, the UV stabilizer including benzotriazole and a colored pigment that offsets a yellow color imparted by the benzotriazole.

6. The vehicle paint system of claim 5 wherein the colored pigment is a red shade of pigment.

7. The vehicle paint system of claim 6 wherein the electro-deposition layer includes epoxy.

8. The vehicle paint system of claim 7 wherein the basecoat has a UV stabilizer including the benzotriazole and the colored pigment that offsets the yellow color imparted by the benzotriazole.

9. A method of applying coatings to a base material of a vehicle component, the method comprising the steps of:
(a) applying an electro-deposition layer to the base material;
(b) applying a basecoat having a UV stabilizer additive to the electro-deposition layer, the UV stabilizer additive including benzotriazole and a colored pigment that offsets a yellow color imparted by the benzotriazole; and
(c) applying a clearcoat to the basecoat.

10. The method of claim 9 wherein step (a) is further defined by applying an anti-corrosion pretreatment to the base material prior to applying the electro-deposition layer.

11. The method of claim 10 wherein the anti-corrosion pre-treatment includes a phosphate.

12. The method of claim 9 wherein step (a) is further defined by the electro-deposition layer being an epoxy-based electro-deposition material that is applied.

13. The method of claim 9 wherein step (c) is further defined by the clearcoat including a UV stabilizer having the benzotriazole and a colored pigment that offsets a yellow color imparted by the benzotriazole.

14. The method of claim 9 wherein step (b) is further defined by the colored pigment being a red shade of pigment.
